(19) United States
(12) Patent Application Publication
(10) Pub. No.: US 2008/0285955 A1
(43) Pub. Date: Nov. 20, 2008

(54) METHOD FOR LOW DATA RATE VIDEO IMAGE STORAGE

(76) Inventors: Che-Sheng Yu, XiZhi City (TW); Jong-Tzy Wang, XiZhi City (TW)

Correspondence Address: ANTHONY R. BARKUME, 20 GATEWAY LANE, MANORVILLE, NY, 11949, US

(21) Appl. No.: 12/119,535

(22) Filed: May 13, 2008

(30) Foreign Application Priority Data
May 14, 2007 (TW) 096117139

(51) Int. Cl. H04N 7/26

(52) U.S. Cl. 386/111; 386/E05.007

(57) ABSTRACT

A method for low data rate video image storage is disclosed in the present invention, comprising following steps: capturing a video image; comparing the video image with a specific video image by a specific comparison solution, to generate a comparison result; based on the comparison result keeping stable without change in a period of time, forming a minified video image and storing the minified video image.

### FIELD OF THE INVENTION

The present invention relates to a method for low data rate video image storage, especially for minifying the image size of recorded video to decrease the image storage space of recorded video.

### BACKGROUND OF THE INVENTION

The traditional security video recording system compares the difference between the current monitoring screen with the previous monitoring screen to judge abnormal situation happened or not. If the difference between the current monitoring screen and the screen in a period of time before is very small, then system will judge that there is no abnormal situation happened.

During this period of time to judge abnormal situation happened or not, considering about the system storage space, the traditional technology will stop image recording to save storage space if no any abnormal situation happened. But the defect is, system has an incorrect judgment and stop video recording due to the tiny difference between monitoring screens when some special abnormal situations happened. On this situation, important information will get lost without any recorded image for reviewing.

If security will be the first priority, the traditional technology will record the video all the time no matter abnormal situation happens or not. The advantage of this solution is, system will record all the video information without any lost even the system parameter setting is not well tuned and causes incorrect judgment. But in general monitoring case, there is no abnormal situation happened in most of the time, and it takes only a few seconds even abnormal situation happened, therefore, recording video all the time will waste many redundant system storage space.

There are several disadvantages in the technologies of traditional technology:

1. If the system which is based on traditional technology stops to record video while no abnormal situation happened, system might have incorrect judgment for abnormal situation and stop video recording due to the tiny difference between monitoring screens, which causes the lost of important video information.

2. If the traditional system records video all the time, it might waste many redundant system storage space due to no any abnormal situation happened in most of the time in general monitoring case.

3. It is a trade off between the important video information lost and system storage space waste in the traditional technology, which increases the difficulty of system parameter setting.

Therefore, the video recording solution how to decrease the system storage space waste and keep all the important video information, is the major topic in the present invention.

### SUMMARY OF THE INVENTION

The objective in the present invention is providing a new and advanced solution for low data rate video image storage while recording video, which minify the image size of recorded video image to decrease the image storage space of recorded video while recording the image all the time, to save the system storage space and keep all the important video information.

According to present invention, a method for low data rate video image storage is disclosed, comprising following steps:

capturing a video image;

comparing the video image with a specific video image by a specific comparison solution, to generate a comparison result;

based on the comparison result keeping stable without change in a period of time, forming a minified video image and storing the minified video image.

In accordance with the present invention, the video image is a recorded video image of security monitoring system.

In accordance with the present invention, the comparison solution compares the pixels numbers of the video image and the specific video image to get the difference for generating the comparison result.

In accordance with the present invention, the specific video image is a previous video image.

In accordance with the present invention, the video image is minified for reducing a storage space of the video image.

In accordance with the present invention, the video image is minified according to the comparison result to decide a shrink rate.

In accordance with the present invention, further comprising a step: providing a previous video image captured before the video image.

In accordance with the present invention, the minified video image and the previous video image are compressed and stored with a video data format.

In accordance with the present invention, the video data format can be one of the following compression formats: JPEG, Motion-JPEG, Moving Picture Experts Group (MPEG), H.263, H.264, or JPEG2000.

In accordance with the present invention, further comprising a step: providing a background image, and combining the background image with the video image to form a combined image, to make the combined image has the same size with the previous video image.

In accordance with the present invention, the combined image and the previous video image are compressed and stored with a video data format.

In accordance with the present invention, the video data format can be one of the following compression formats: JPEG, Motion-JPEG, Moving Picture Experts Group (MPEG), H.263, H.264, or JPEG2000.

In accordance with the present invention, the background image is a blankness background image.

In accordance with the present invention, the image size will not be minified on the comparison result with difference between the video image and the specific video image.

The present invention may best be understood through the following description with reference to the accompanying drawings, in which:

### BRIEF DESCRIPTION OF THE DRAWINGS

FIG. 1 shows the process flow diagram of the solution for low data rate video image storage while recording video according to the present invention;

FIG. 2 shows the diagram of the solution for low data rate video image storage while recording video according to the present invention;

FIG. 3 shows the diagram of the solution for low data rate video image storage while recording video according to the present invention, which enhances the efficiency of monitoring abnormal situation judgment.

### DETAILED DESCRIPTION OF THE PREFERRED EMBODIMENT

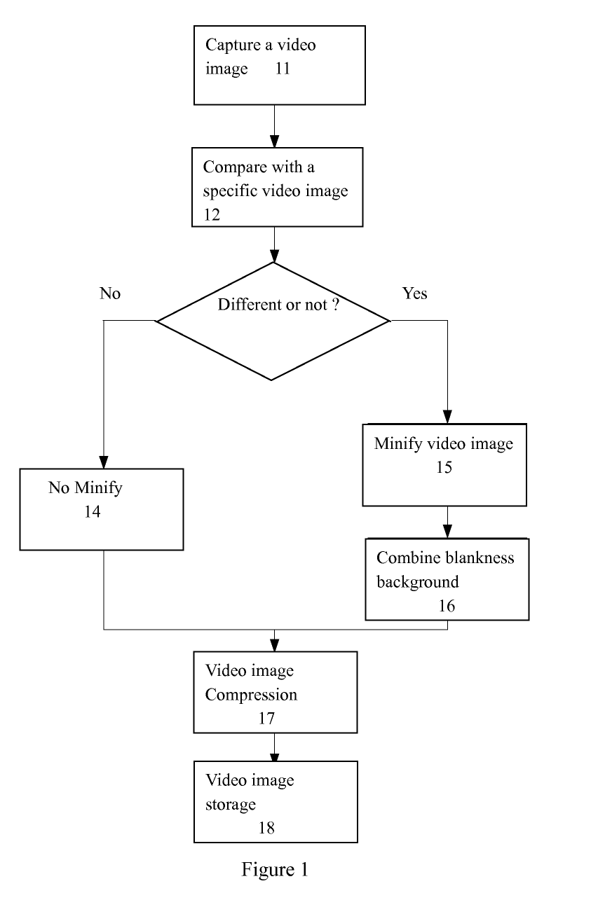

FIG. 1 shows the flow chart of the solution for low data rate video image storage while recording video according to the present invention, comprising following steps:

Step 11: Capturing a video image;

Step 12: Comparing with a specific video image;

Step 13: Is the comparing result different or not;

Step 14: Not minifying image size if the comparing result is different;

Step 15: minifying video image if the comparing result is same;

Step 16: Combining with a blankness background;

Step 17: Compressing video image;

Step 18: Storing video image.

The solution for low data rate video image storage while recording video according to the present invention will capture an video image by Step 11 firstly, and comparing this captured video image with a specific video image in Step 12, in which the specific video image can be the captured video image in advanced or a pre-setting video image; the comparing solution is comparing the pixels numbers of the two video images in Step 13, if the comparing result of these two video images is different, then not minifying the image size in Step 14 but compressing the image in Step 17 directly and storing image as a file in Step 18; if the comparing result of these two images is same, then minifying the image size in Step 15; after minifying the image size, because the minified image cannot be saved as a single video file due to the image size is different from the previous image size, this minified video image has to be combined with a blankness background as a combined image for the same size with the previous video image, to decrease the required space of image storage, and moving to Step 17 for compressing video image and Step 18 for storing video image.

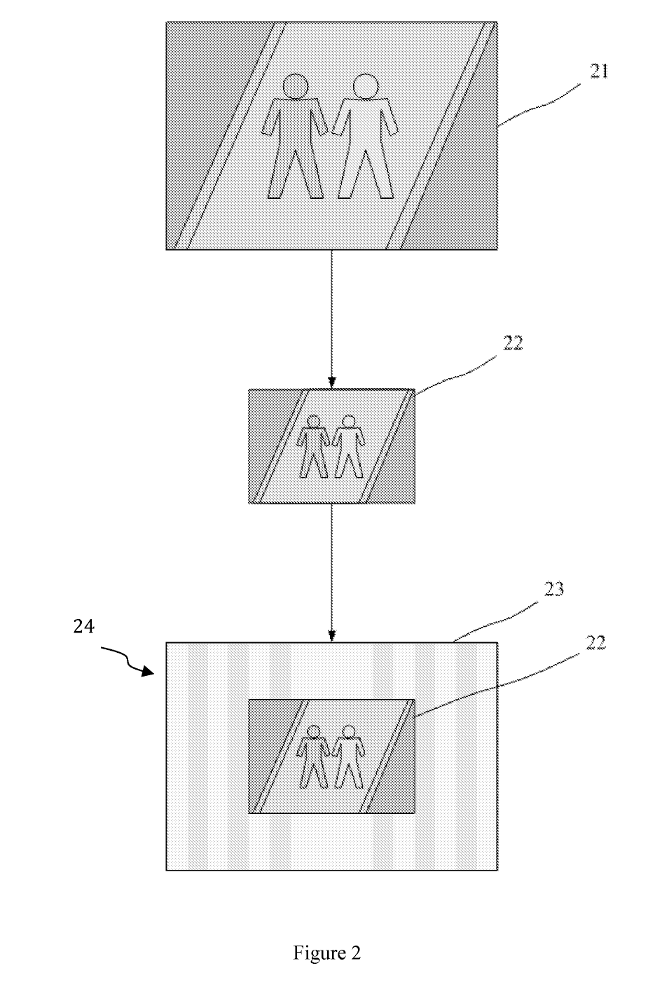

FIG. 2 shows the diagram of the solution for low data rate video image storage while recording video according to the present invention, which contains an original video image 21, compressed sized image 22, blankness background 23, and combined video image 24.

Original video image 21 is capturing the image of two persons staying on the road, after a period of time, if there is no major difference between the two captured images and system would judge the comparison result as the same, then system will shrink the captured image size as a minified video image 22, and system will combine this minified video image 22 with a blankness background 23 as the back ground to make this minified video image 22 can be compressed with the previous image as a single video file. The video image of this blankness background 23 is able to make the combined image 24 which integrates the blankness background 23 and minified video image 22 occupy a less storage space.

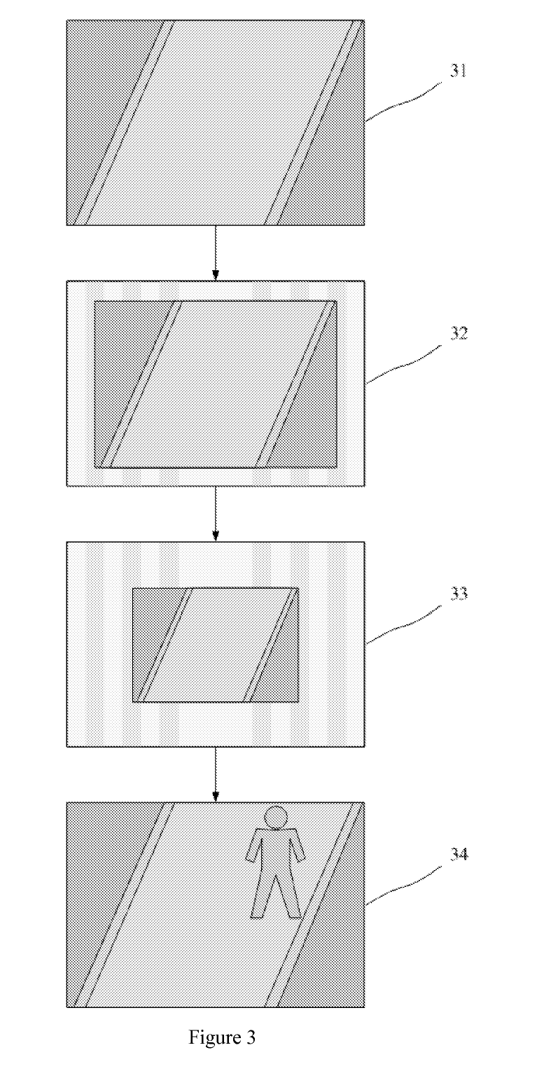

FIG. 3 shows the example in the solution for low data rate video image storage while recording video according to the present invention, which enhances the judgment effect of abnormal monitoring situations and comprises video image 31, minified video image 32 with same comparison result in a period of short time, minified video image 33 with same comparison result in a period of long time, and video image 34 with different comparison result 34.

If video image 31 (or an image) keeps the same in a period of short time, system would minify the image size of video image 31 as a minified video image 32 with same comparison result in a period of short time (or the first combination image); after a period of longer time, system would increase the shrink (minifying) rate to minify the image size of video image 31 as a minified video image 33 with same comparison result in a period of long time (or the second combination image). Therefore, the monitoring manager is able to know how long this monitoring screen has kept without change through the shrink rate. If the monitoring screen changes suddenly, system will not minify the image size of video image 31 because the comparison result is different from the previous video image, but shows out the video image with the original sized video image 34 with different comparison result; this solution which recovers the image size back to original size when abnormal situation is happened in the monitoring screen is able to attract the attention of monitoring manager and shorten the response time to discover the abnormal situation.

There are several advantages of the present invention:

1. In accordance with the solution for low data rate video image storage while recording video according to the present invention, if the video image keeps the same without any change during a period of time, minifying the image size and storing is able to decrease the required image storage space.

2. In accordance with the solution for low data rate video image storage while recording video according to the present invention, if the video image keeps the same without any change during a period of time, minifying the image size and storing will not lost any important information.

3. In accordance with the solution for low data rate video image storage while recording video according to the present invention is able to decrease the effect of incorrect system parameter setting.

4. In accordance with the solution for low data rate video image storage while recording video according to the present invention, combining a blankness background with the video image is able to keep the same image size with the previous image to solve the issue of compressing as a single video file.

5. Monitoring manager is able to discover any abnormal situation happened in the monitoring screen by the monitoring image size.

To sum up, the solution for low data rate video image storage while recording video according to the present invention is able to decrease the image storage space and keep on recording the image all the time by minifying the image size, which saves the system storage space and without any important information lost. Any other modified design such as fixing the size shrink rate, combining with different blankness background, storing image file without combining the blankness background, or comparing by non-pixel solution, all belong to the disclosures in the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims to be accorded with the broadest interpretation so as to encompass all such modifications and similar solutions.

What is claimed is:

1. A method for low data rate video image storage comprising following steps:
capturing a video image;
comparing the video image with a specific video image by a specific comparison solution, to generate a comparison result;
based on the comparison result keeping stable without change in a period of time, forming a minified video image and storing the minified video image.

2. A method according to claim 1 wherein the video image is a recorded video image of security monitoring system.

3. A method according to claim 1 wherein the comparison solution compares the pixels numbers of the video image and the specific video image to get the difference for generating the comparison result.

4. A method according to claim 1 wherein the specific video image is a previous video image.

5. A method according to claim 1 wherein the video image is minified for reducing a storage space of the video image.

6. A method according to claim 1 wherein the video image is minified according to the comparison result to decide a shrink rate.

7. A method according to claim 1 wherein further comprising a step: providing a previous video image captured before the video image.

8. A method according to claim 7 wherein the minified video image and the previous video image are compressed and stored with a video data format.

9. A method according to claim 8 wherein the video data format can be one of the following compression formats: JPEG, Motion-JPEG, Moving Picture Experts Group (MPEG), H.263, H.264, or JPEG2000.

10. A method according to claim 7 wherein further comprising a step: providing a background image, and combining the background image with the video image to form a combined image, to make the combined image has the same size with the previous video image.

11. A method according to claim 10 wherein the combined image and the previous video image are compressed and stored with a video data format.

12. A method according to claim 11 wherein the video data format can be one of the following compression formats: JPEG, Motion-JPEG, Moving Picture Experts Group (MPEG), H.263, H.264, or JPEG2000.

13. A method according to claim 10 wherein the background image is a blankness background image.

14. A method according to claim 1 wherein the image size will not be minified on the comparison result with difference between the video image and the specific video image.
